(19) United States
(12) Patent Application Publication
(10) Pub. No.: US 2024/0325946 A1
(43) Pub. Date: Oct. 3, 2024

(54) DISCHARGING DEVICE OF A PRESS SCREW SEPARATOR

(71) Applicant: RÖHREN- UND PUMPENWERK BAUER GES.M.B.H., Voitsberg (AT)

(72) Inventor: Otto ROISS, Graz (AT)

(21) Appl. No.: 18/580,846

(22) PCT Filed: Jul. 18, 2022
(86) PCT No.: PCT/EP2022/070035

§ 371 Date: Jan. 19, 2024

(30) Foreign Application Priority Data
Jul. 22, 2021 (DE) 10 2021 119 019.3

(51) Int. Cl. B01D 29/94; B01D 29/35; B01D 29/60; B01D 29/68; B01D 35/147; B30B 9/12; B30B 9/18; C02F 11/125

(52) U.S. Cl. CPC B01D 29/94; B01D 29/35; B01D 29/60; B01D 29/68; B01D 35/1475; B30B 9/125; B30B 9/18; C02F 11/125; B01D 2201/16

(57) ABSTRACT

The invention relates to a discharging device of a press screw separator for separating solid components from a slurry containing solid and liquid components, comprising a tube to be arranged at the solids outlet of the press screw separator, a closing cone, which can be moved into and out of the tube, to form an outlet gap between the tube and the closing cone, an actuator for applying a counterforce to the closing cone, and an actuator control unit, which is configured to control the actuator based on a variable operating parameter signal of an electric motor of the press screw separator.

### CROSS-REFERENCE TO RELATED APPLICATIONS

This application is a National Stage of International Application No. PCT/EP2022/070035, filed Jul. 18, 2022, which claims priority based on German Patent Application No. 102021119019.3, filed Jul. 22, 2021, the entire disclosures of which are incorporated herein by reference.

### TECHNICAL FIELD

The invention relates to a press screw separator and a discharging device of a press screw separator. Furthermore, the invention shows a method for separating solid components from a slurry using the press screw separator.

### BACKGROUND

Press screw separators are used for pressing out a slurry. The slurry can be, for example, liquid manure or waste water. Furthermore, the slurry can be a mass of fruit or vegetables to be pressed out. The waste water can come from agricultural, municipal or industrial facilities or slaughterhouses, for example.

Press screw separators have a housing, in which a cylindrical or conical sieve is arranged. A press screw rotates within the sieve. The press screw conveys and presses the slurry through the press screw separator. The liquid parts of the slurry pass through the sieve radially outwards and flow off. A solids plug forms inside the sieve or at the end of the sieve, which is conveyed to one end by the rotating press screw. At this end of the housing there is usually a discharging device (also: discharging regulator) disposed. The discharging device generates a counterforce acting on the solids plug, which acts against the conveying direction of the pressing screw.

### SUMMARY

The object of the present invention is to provide a discharging device for a press screw separator, which enables an efficient pressing out of the slurry with simple and low-maintenance operation.

The solution to this object is provided by the features of the independent claims; the subject matter of the dependent claims is preferred embodiments of the invention.

The discharging device comprises a tube to be arranged at the solids outlet of the press screw separator. In particular, the tube is designed to be connected to a casing of the press screw separator, whereby, for example, a flange is provided on the tube for this purpose. However, the tube can also be an integral part of the casing of the press screw separator.

In addition to the tube, the discharging device comprises a closing cone that can be extended and retracted into the tube. The closing cone is arranged so that the tip end of the cone protrudes into the tube; the tip end of the closing cone can, for example, be formed in a pointy or frustoconical shape. An annular outlet gap is created between the outer circumference of the closing cone and the inner circumference of the tube, the size of which can be varied by moving the closing cone in and out. The solids separated in the press screw separator exits to the outside via this outlet gap.

The discharging device comprises an actuator for moving the closing cone and, in particular, for applying a counterforce on the exiting solids plug. This actuator is operatively connected to the closing cone and is arranged, in particular, to move the closing cone coaxially to the conveying direction of the press screw separator. An actuator control unit is provided to control the closing cone. In particular, the actuator control unit is configured to vary the counterforce applied with the closing cone.

The actuator control unit is configured to control the actuator based on a variable operating parameter signal from an electric motor of the press screw separator. The electric motor of the press screw separator refers to the driving of the press screw of the press screw separator. The operating parameter signal, which is used to control the actuator control unit, changes when the electric motor is running, in particular with the output power of the electric motor and/or the rotation speed of the electric motor, and is therefore termed a “variable” operating parameter signal.

The control of the actuator and thus the change of the counterforce on the solids plug is based on the operating parameter signal of the electric motor and enables very precise control of the TS content (dry matter content) of the exiting solids plug. In particular, it is provided that the actuator control unit is configured to reduce the counterforce when the operating parameter signal results in an increase in the output power of the electric motor.

A data input for a date transmission of the operating parameter signal or a signal based on the operating parameter signal is preferably provided at the actuator control unit. This data transmission is preferably cable-bound, so that the data input is formed, for example, as a plug or other input for a cable-bound data transmission.

The actuator is preferably a pressure-medium cylinder. The pressure-medium cylinder is in particular a pneumatic cylinder. In particular, the pressure-medium cylinder is arranged coaxially to the movement direction of the closing cone, so that the movement of the pressure-medium cylinder can be directly transmitted to the closing cone without a transmission or other mechanics.

The actuator control unit preferably comprises a pressure control valve, in particular a proportional pressure control valve. A pressure reducer is preferably connected upstream of the pressure control valve. The change of the counterforce, i.e. in particular the change of the pressure in the pressure-medium cylinder, is preferably carried out via the pressure control valve. In particular, the pressure control valve is configured for actuation based on the operating parameter signal.

For precise adjustment of the counterpressure, it is preferably provided that the pressure control valve comprises a maximum pressure hysteresis of at most 0.5 bar, preferably at most 0.25 bar.

Furthermore, it is preferably provided that the pressure control valve comprises a linearity error FS (Full Scale) of at most 5%, preferably at most 3%, particularly preferably at most 2%.

A maintenance unit for dehumidifying the compressed air is preferably connected upstream of the pressure control valve. Additionally or alternatively, an ultra-fine filter is preferably connected upstream of the pressure control valve. Damage to the pressure control valve is avoided via the ultra-fine filter. The maintenance unit and/or the ultra-fine filter and/or the pressure reducer and/or the pressure control valve can be combined in one component.

Furthermore, it is preferably provided that the actuator control unit comprises a terminal for connecting to a higher-level pressure supply pipe. In particular, this terminal leads to the pressure reducer of the actuator control unit in a pressure-conducting manner. In particular, it is provided that the discharging device and the press screw separator do not comprise their own pump for generating the pressure for the pressure-medium cylinder, but are connected to a higher-level pressure supply pipe via the terminal. The pressure supply pipe is termed “higher-level”, because it can supply pressure to any other devices within a building in addition to the discharging device.

The tube of the discharging device is preferably conical on the inner circumference. Preferably, it is conical via at least 80% of its length at the inner circumference. In particular, it is provided that the tube is conical via at least 90%, particularly preferably 100%, of its length at the inner circumference. This largely conical design of the tube prevents clogging within the tube.

Furthermore, the discharging device preferably comprises a receptacle. This receptacle extends from the tube, for example from the flange of the tube, and carries the actuator. A rod extending from the actuator, in particular a piston rod, can be connected to the closing cone directly or via a coaxial extension.

The invention further comprises a press screw separator. The press screw separator comprises the discharging device already described, so that the advantageous designs described with regard to the discharging device and the associated dependent claims are also preferably applicable to the press screw separator.

The press screw separator comprises a casing. The tube of the discharging device can be flange-mounted to this casing. However, it is also possible that the tube of the discharging device is an integral part of the casing.

A solids outlet is defined on the casing. This solids outlet represents the transition to the tube of the discharging device. The solids plug is formed at this solids outlet and within the tube of the discharging device.

A sieve is disposed in the casing of the press screw separator. In turn, a press screw is rotatably arranged in the sieve. The press screw comprises, in particular, a core and at least one helix arranged thereon. The press screw, in particular the core of the press screw, extends along a conveying direction of the press screw separator. The slurry is pressed out along this conveying direction and the solids are conveyed. The described counterforce of the discharging device acts against the conveying direction.

An electric motor of the press screw separator is provided for rotatingly driving the press screw. The operating parameter signal for controlling the actuator of the discharging device is based on an operating parameter of the running electric motor.

The press screw separator preferably comprises motor electronics. The motor electronics can basically be configured to control the electric motor and/or to measure the electric motor. The motor electronics is also configured to send the operating parameter signal of the electric motor to the actuator control unit. Preferably, the motor electronics comprise a frequency converter that controls the electric motor, wherein the frequency converter generates the operating parameter signal.

In particular, the motor electronics is configured to output a power-dependent current signal or power-dependent voltage signal of the running electric motor as an operating parameter signal.

The actuator control unit is preferably configured to reduce the counterforce, in particular the pressure of the pressure-medium cylinder, as the power of the electric motor increases. For example, if the current consumption of the electric motor increases, the counterforce at the closing cone is reduced, which increases the outlet gap. As a result, the current consumption at the electric motor drops and the counterpressure is increased again. This control makes it possible, for example, to operate the electric motor in a desired power range, e.g. at 80% of the nominal current.

During the development, it has been found that, in particular for slurries with little structure—for example, few or short fibers—a precise control of the counterpressure at the discharging device is necessary in order to achieve a desired TS content. In particular, the desired TS content is the highest possible TS content of the solids. For this reason, it is provided in particular that, as already mentioned, the actuator control unit comprises a pressure control valve. This preferably has a setting range of up to a maximum of 10 bar, preferably up to a maximum of 5 bar.

Particularly decisive for the precise control of the TS content is the counterforce applied with the closing cone. However, the higher this counterforce is, the more complex the design of the actuator and the actuator control unit becomes, when precise adjustment of the counterforce is required. For this reason, it is preferably provided that the actuator control unit is configured to vary the counterforce only up to an upper limit. This upper limit is preferably 10 kN (kilonewtons), in particular 8 kN, especially preferably 5 kN.

Preferably, the press screw separator comprises at least one washing nozzle arranged to spray liquid, in particular water, on the sieve. In particular, the washing nozzle is disposed outside the sieve and sprays on the sieve from the outside. Preferably, a washing nozzle control unit is provided, which can be integrated into the motor electronics. The control of the washing nozzle, i.e. the switching on of the washing nozzle, is preferably based on a variable operating parameter signal of the electric motor, in particular on the variable operating parameter signal described above. The invention further comprises a method for separating solid components from a slurry containing solid and liquid components. An operation of a press screw separator is carried out. In particular, it refers to the press screw separator already described. The press screw separator for performing the method comprises at least one press screw, which produces and conveys a solids plug from the slurry along a conveying direction, and an electric motor for rotatingly driving the press screw. The press screw separator is also provided with a discharging device, which applies a counterforce to the solids plug via an actuator against the conveying direction. The discharging device is preferably the discharging device already described.

According to the method, the variable operating parameter signal of the running electric motor is obtained. As already described, the variable operating parameter signal is preferably directly or indirectly dependent on the power output by the electric motor. In particular, it is the current power consumption of the electric motor. Furthermore, according to the method, the actuator is controlled based on this operating parameter signal.

The advantageous designs described according to the discharging device of the invention and according to the press screw separator of the invention and the corresponding dependent claims find correspondingly advantageous use of the method.

### BRIEF DESCRIPTION OF THE DRAWINGS

Further details, advantages and features of the present invention are apparent from the following description of an embodiment with reference to the drawing. It shows:

FIG. 1 is a schematic view of a press screw separator of the invention with discharging device of the invention for performing the method of the invention according to an embodiment, and

FIG. 2 is an illustration of the discharging device according to the invention according to the embodiment.

### DETAILED DESCRIPTION

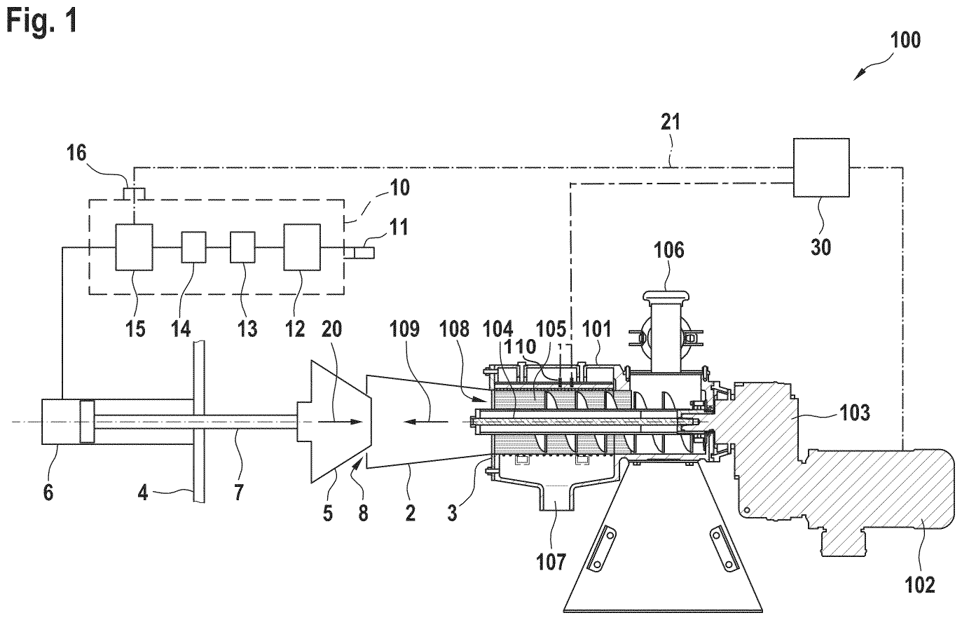

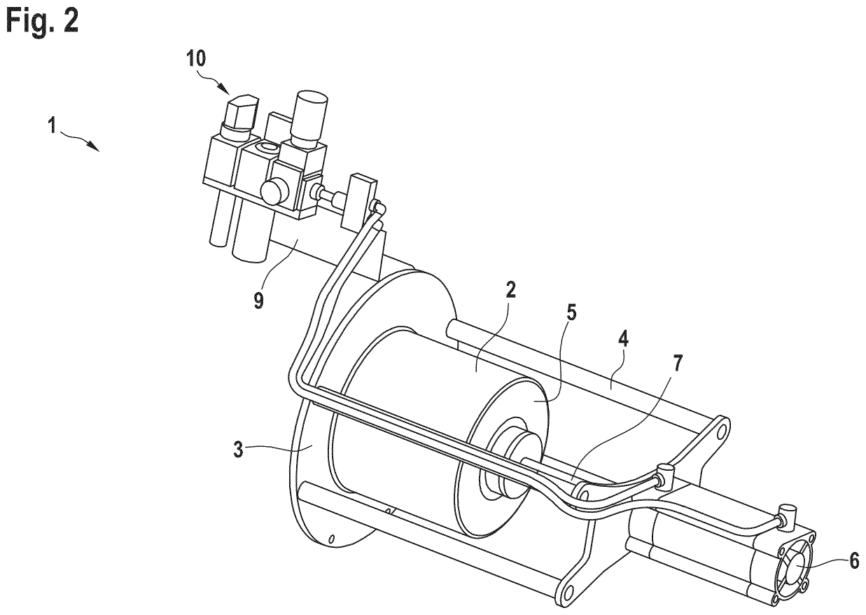

In the following, a press screw separator 100 with discharging device 1 for performing a method for separating solid components from a slurry containing solid and liquid components is described with reference to FIGS. 1 and 2. Unless otherwise mentioned in detail, reference is always made to both figures.

The press screw separator 100 comprises a casing 101, to which a gearing 103 is flange-mounted. The gearing 103 is drive-connected to an electric motor 102.

A sieve 105 is disposed in the casing 101. A press screw 104 is arranged in the sieve 105. The press screw 104 is horizontal and extends along a conveying direction 109 of the press screw separator 100.

The pressing screw 104 is drive-connected via the gearing 103 with the electric motor 102.

An inlet 106 for filling the slurry is formed at the topside of the casing 101. An outlet 107 for discharging the liquid components of the slurry is disposed at the underside of the casing 101.

The gearing 103 is arranged at one end side of the casing 101. A solids outlet 108 is defined at the opposing end side. The discharging device 1 is flange-mounted to this solids outlet 108.

The discharging device 1 comprises a tube 2 with a conical inner circumference. The tube 2 comprises a flange 3, which is fixed to the solids outlet 108 of the casing 101.

Furthermore, the discharging device 1 comprises a receptacle 4 arranged at the flange 3. An actuator 6, which is formed as a pressure-medium cylinder, in particular a pneumatic cylinder, is in turn fixed to this receptacle 4.

Furthermore, the discharging device 1 comprises a closing cone 5, which can be extended and retracted into the tube 2 via a rod 7 coaxially to the conveying direction 109 by means of the actuator 6. The rod 7 can be the piston rod of the actuator 6 or a correspondingly extension of this piston rod.

An annular outlet gap 8 for the solids is formed between the closing cone 5 and the tube 2.

Via the closing cone 5 and the actuator 6, a counterforce 20 is applied on the solids, which acts against the conveying direction 109.

The discharging device 1 further comprises an actuator control unit 10. The actuator control unit 10 comprises a pressure reducer 12 and a pressure control valve 15. Furthermore, the actuator control unit 1 comprises a maintenance unit 13 for dehumidifying the compressed air and an ultra-fine filter 14. The structure of the actuator control unit 10 is shown schematically, wherein the functional components can be combined into assemblies as desired.

Furthermore, the actuator control unit 10 comprises a terminal 11 for connecting a compressed air line to the pressure reducer 12 and a data input 16. In particular, the data input 16 leads to the pressure control valve 15.

FIG. 1 shows a schematic view of a motor electronics unit 30, which can be arranged at any position in the constructive implementation. The motor electronics 30, in particular with a frequency converter, is configured to send a variable operating parameter signal 21 of the running electric motor 102 to the actuator control unit 10. In addition, the motor electronics 30 can also be used to control the electric motor 102.

In particular, the operating parameter signal 21 is a current signal or voltage signal. Based on the operating parameter signal 21, the actuator control unit 10, in particular the pressure control valve 15, is controlled, wherein the pressure control valve 15 is preferably formed as a proportional pressure control valve for this purpose.

The press screw separator 100 preferably comprises at least one wash nozzle 110 arranged to spray water on the sieve 105. A washing nozzle control unit is preferably integrated into the motor electronics 30. The wash nozzle 110 is controlled, in particular, based on the variable operating parameter signal 21.

FIG. 2 shows in detail the constructive design of the discharging device 1. A holder 9 is shown, which extends from the tube 2, in particular from the flange 3, in the direction of the press screw separator 100 and is formed in particular in such a way that it extends via the casing 101 of the press screw separator. The holder 9 serves to hold at least part of the actuator control unit 10. In particular, the pressure reducer 12 and the pressure control valve 15 are fixed to the holder 9.

1. A discharging device of a press screw separator for separating solid components from a slurry containing solid and liquid components, comprising:
a tube to be arranged at the solids outlet of the press screw separator,
a closing cone, which can be moved into and out of the tube to form an outlet gap between the tube and the closing cone,
an actuator to apply a counterforce to the closing cone, and
an actuator control unit, which is adapted to control the actuator based on a variable operating parameter signal of an electric motor of the press screw separator.

2. The discharging device of claim 1, wherein the actuator control unit comprises a data input for a data transmission of the operating parameter signal.

3. The discharging device of claim 1, wherein the actuator is adapted as pressure-medium cylinder, preferably pneumatic cylinder.

4. The discharging device of claim 3, wherein the pressure-medium cylinder is disposed coaxially to the movement direction of the sealing cone.

5. The discharging device of claim 1, wherein the actuator control unit comprises a pressure control valve, in particular a proportional pressure control valve, which is actuatable with the operating parameter signal.

6. The discharging device of claim 5, wherein the pressure control valve comprises a maximum pressure hysteresis of at most 0.5 bar, preferably at most 0.25 bar.

7. The discharging device of claim 5, wherein the pressure control valve comprises a linearity error FS (Full Scale) of at most 5%, preferably at most 3%, particularly preferably at most 2%.

8. The discharging device of claim 1, wherein the actuator control unit comprises a port to connect a superordinated pressure supply pipe.

9. The discharging device of claim 5, wherein a pressure reducer is connected upstream of the pressure control valve.

10. The discharging device of claim 5, wherein a maintenance unit to dehumidify the compressed air is connected upstream of the pressure control valve.

11. The discharging device of claim 5, wherein an ultra-fine filter is connected upstream of the pressure control valve.

12. The discharging device of claim 1, wherein the tube is conical at the inner circumference, in particular is conical via at least 80%, preferably at least 90%, particularly preferably 100%, of its length at the inner circumference.

13. The discharging device of claim 1, wherein the tube comprises a flange to be fixed to the press screw separator.

14. A press screw separator for separating solid components from a slurry containing solid and liquid components, comprising:
a housing with a solids outlet,
a sieve disposed in the housing,
a pressing screw rotatably disposed in the sieve,
an electric motor driving the pressing screw,
a discharging device disposed at the solids outlet, according to any of the preceding claims.

15. The press screw separator of claim 14, comprising a motor electronics driving the electric motor and/or measuring at the electric motor, which is adapted to detect the operating parameter signal of the electric motor.

16. The press screw separator of claim 15, wherein the motor electronics comprises a frequency converter controlling the electric motor, wherein the frequency converter generates the operating parameter signal.

17. The press screw separator of claim 15, wherein the motor electronics is adapted to detect a power-dependent current signal as operating parameter signal.

18. The press screw separator of claim 17, wherein the motor electronics is adapted to convert the power-dependent current signal into a voltage signal to control the actuator.

19. The press screw separator of claim 14, wherein the actuator control unit is adapted to reduce the counterforce, in particular the pressure of the pressure-medium cylinder, as the power of the electric motor increases.

20. The press screw separator of claim 14, wherein the actuator control unit is adapted to vary the counterforce up to an upper limit of 10 kN, preferably 8 kN, particularly preferably 5 kN.

21. The press screw separator of claim 14, comprising at least one washing nozzle, disposed to spray liquid onto the sieve; and preferably comprising a washing nozzle control unit, in particular integrated in the motor electronics, which is adapted to control the washing nozzle based on the variable operating parameter signal of the electric motor of the press screw separator.

22. A method of separating solid components from a slurry containing solid and liquid components, comprising the following steps:
operating a press screw separator, preferably according to claim 14,
with a press screw, which produces and conveys a solids plug from the slurry along a conveying direction,
with an electric motor to drive the press screw rotationally
and with a discharging device, which generates a counterforce on the solids plug via an actuator against the conveying direction,
obtaining a variable operating parameter signal from the running electric motor, and
controlling the actuator based on the operating parameter signal.
